(19) United States
(12) Patent Application Publication
(10) Pub. No.: US 2025/0199799 A1
(43) Pub. Date: Jun. 19, 2025

(54) AN ELECTRONIC DEVICE CAPABLE OF SEAMLESS FIRM WEAR UPDATES AND A METHOD OF BOOTING FROM THAT ELECTRONIC DEVICE

(71) Applicant: TELECHIPS INC., Seongnam-si (KR)

(72) Inventors: Moon Soo KIM, Seongnam-si (KR); Jin Wook SHIN, Seongnam-si (KR)

(21) Appl. No.: 18/960,752

(22) Filed: Nov. 26, 2024

(30) Foreign Application Priority Data
Dec. 13, 2023 (KR) 10-2023-0180689

(51) Int. Cl. G06F 8/654

(52) U.S. Cl. CPC G06F 8/654

(57) ABSTRACT

Provided is an electronic device capable of seamless firmware updating including a processor having a first firmware stored in a single flash memory supporting a software execution (eXecute in place (XiP)) function using an external memory, an external memory located outside the processor and not having an XiP function storing a second firmware, and an interface receiving a third firmware from an external system having the third firmware through communication with the external system via OTA (Over The Air).

### CROSS REFERENCE TO RELATED APPLICATION

The present application claims the benefit of priority under 35 U.S.C. § 119 (a) to Korea Patent Application Serial No. 10-2023-0180689, filed in the Korean Intellectual Property Office on Dec. 13, 2023, the contents of which are hereby incorporated by reference in their entirety.

### BACKGROUND

### Field

The present disclosure relates to firmware updating of a processor, and more particularly, to an electronic device capable of seamless firmware updating and a booting method using the electronic device.

### Description of Related Art

Recently, a seamless firmware updating method has been widely used in systems supporting OTA (Over The Air) updates in the automotive field.

The reason for this is that an operable booting system is advantageously maintained in flash memory, while OTA updating is in progress and that even if firmware (F/W) updating fails, it is possible to maintain availability by booting with the existing F/W.

FIG. 1 in the prior art is a diagram illustrating firmware updating process of a processor having existing flash memory and a firmware change operation during booting.
(a) of FIG. 1 illustrates that firmware A is stored in a flash memory 112 that supports the software execution (execute in Place (XiP)) function using an external memory of the processor 110, and (b) of FIG. 1 illustrates that existing firmware A is updated to firmware B in the flash memory 112 for XiP of the processor 110 through OTA and the firmware B is executed by a boot loader 120 of the processor 110 during booting.

In a process 150 of updating new firmware B from an external system 100, the flash memory 112 for XiP is in the process of being written from firmware A to new firmware B, so a blanking period of firmware occurs in the flash memory 112 for XiP, and a device 111 inside the processor 110 has a problem in that it cannot perform the operation of the firmware A in the flash memory 112 for XiP of the processor 110 during the update.

FIG. 2 in the prior art is a drawing illustrating firmware updating process of a processor having an existing dual bank and a firmware change operation during booting.

As shown in (a) of FIG. 2, the processor 210 may include a first flash memory 212 for XiP and a second flash memory 213 for XiP. Firmware A is stored in the first flash memory 212, and firmware B is updated in the second flash memory 213 of the processor 110 from an external system 200, and during the update, an internal or external device 211 of the processor 210 may use the firmware stored in the first flash memory 212, so that a seamless operation may be performed.
(b) of FIG. 2 illustrates the processor 210 after the update, and at the time of booting after the update, a boot loader 221 of the processor 210 selects 224 a bank to be used from the first flash memory 212 to the second flash memory 213, thereby executing firmware B.

The method of FIG. 2 has the advantage that the processor 210 may execute firmware in the flash memory 1 212 for XiP even while updating is in progress, and may maintain availability by booting with the existing firmware A even when firmware updating fails. However, there is a problem in that the size of the chip increases and the unit price of the chip also increases by using the processor having two flash memories.

### SUMMARY

The present disclosure provides an electronic device capable of performing seamless firmware updating using a legacy processor having one flash memory for XiP therein and an external memory for non-XiP, and a booting method using the electronic device.

In an aspect, an electronic device capable of seamless firmware updating includes: a processor having a first firmware stored in a single flash memory supporting a software execution (eXecute in place (XiP)) function using an external memory; an external memory located outside the processor and not having an XiP function storing a second firmware; and an interface receiving a third firmware from an external system having the third firmware through communication with the external system via OTA (Over The Air).

The processor and the external memory may be connected by a data line, and the third firmware of the external system may be transmitted to the external memory and written through the data line.

The interface may be connected to the processor, and the third firmware received through the interface may be transmitted to the external memory via the processor and written to the external memory.

The external memory may be partitioned into a plurality of banks, and each of the partitioned banks may store different firmware.

The electronic device may further include: a controller determining a write location in one of the partitioned banks for firmware to be updated stored in a non-volatile memory of the processor by checking a flag indicating a version or presence of different firmware written in each of the partitioned banks of the external memory.

In another aspect, a booting method of a processor in an electronic device capable of seamless firmware updating, including a processor supporting a software execution (eXecute in place (XiP)) function using an external memory, an external memory located outside the processor and not having an XiP function, and an interface receiving a firmware from an external system having the firmware through communication with the external system via OTA (Over The Air), the booting method after updating the firmware includes: an operation in which the processor attempts to boot using an existing boot loader; an operation in which, when the booting is successful, the processor enters a boot loader added in an updating process, and the added boot loader searches the external memory for an available bank; an operation in which, when there is a new firmware in an available bank, the boot loader copies the new firmware to a flash memory inside the processor; and an operation in which authentication of the new firmware copied to the flash memory inside the processor is successful and booting using the new firmware is successful, a main function of the new firmware is entered.

The operation in which the added boot loader searches the external memory for an available bank may include searching for a bank with a history of the latest firmware updating.

The booting method may further include: an operation in which, when the authentication of the new firmware copied to the flash memory fails or the booting using the new firmware fails, the existing firmware in the existing bank is copied to the internal flash memory of the processor, and a main function of the existing firmware is performed after rollback.

In another aspect, an electronic device capable of seamless firmware updating includes: a plurality of processors having firmware being executed in flash memory supporting an execute in place (XiP) function using external memory; one external memory located outside the plurality of processors and not having an XiP function for storing the plurality of firmware; and at least one interface receiving firmware to be updated from an external system having the firmware to be updated through OTA (Over The Air) communication with the external system.

The plurality of processors and the one external memory may be connected by a data line, and the firmware to be updated may be transmitted and written from the plurality of processors to the one external memory through the data line.

The at least one interface may be connected to the plurality of processors, and the firmware to be updated received through the at least one interface may be transmitted to the one external memory via the plurality of processors and written to the one memory.

The one external memory may be partitioned into a plurality of banks, and each of the partitioned banks may store different firmware.

The electronic device may further include: a controller determining a write location in one of the partitioned banks for firmware to be updated stored in a non-volatile memory of the plurality of processors by checking a flag indicating a version or presence of different firmware written in each of the partitioned banks of the one external memory.

According to the electronic device capable of seamless firmware updating and the booting method using the electronic device of the present disclosure, seamless firmware updating may be supported, while using a legacy processor having one flash memory for XiP.

In addition, the present disclosure may be implemented at lower costs than an updating device using the existing dual flash memory.

Meanwhile, it is possible to update using OTA, while using a processor smaller in size than a processor having a dual flash memory.

In addition, there is no limit to the number of firmware that may be backed up depending on the size of an external flash memory in the updating device using OTA.

### BRIEF DESCRIPTION OF THE DRAWING

FIG. 1 in the prior art is a drawing illustrating firmware updating process and a firmware change operation during booting of the existing processor having one flash memory.

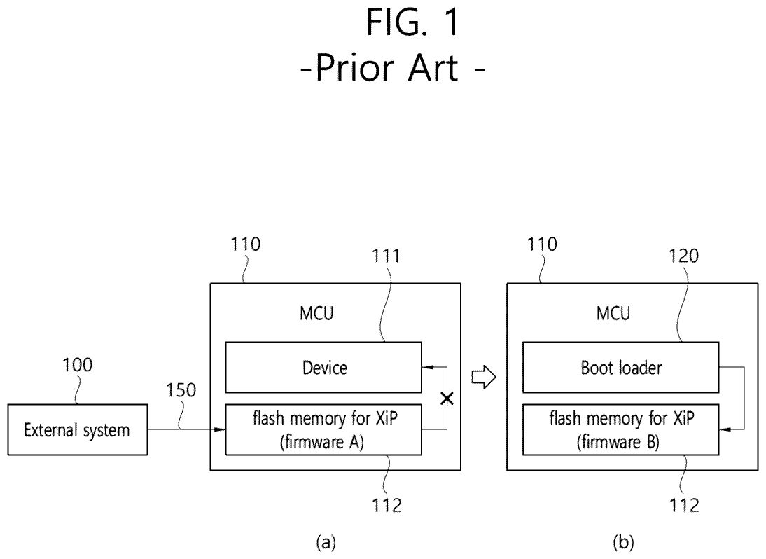

FIG. 2 in the prior art is a drawing illustrating firmware updating process and a firmware change operation during booting of the existing processor having dual banks.

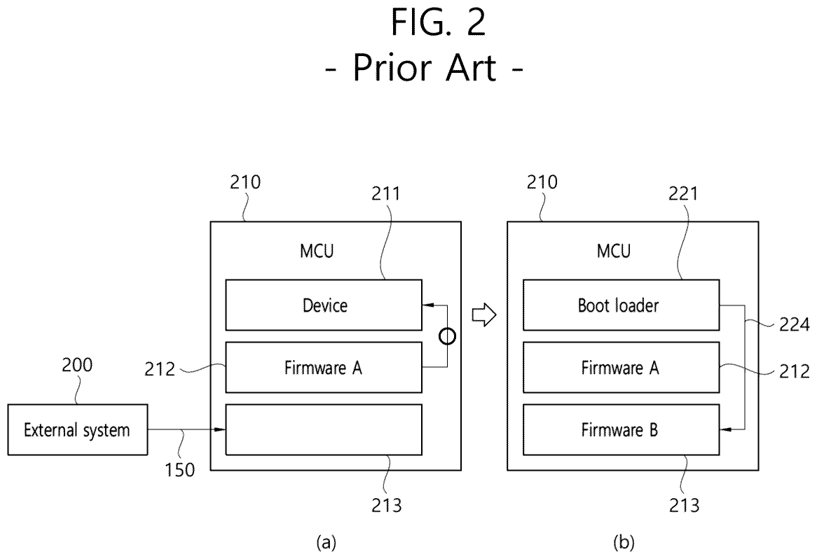

FIG. 3 is a drawing illustrating firmware updating using a processor assembly and a firmware change operation during booting in a processor assembly according to an embodiment of the present disclosure.

FIG. 4 is a diagram illustrating firmware updating using a processor assembly and a firmware change operation during booting in a processor assembly according to another embodiment of the present disclosure.

FIG. 5 is a flowchart of a processor booting after firmware updating of the processor according to an embodiment of the present disclosure.

### DETAILED DESCRIPTION

Hereinafter, an embodiment of the present disclosure will be described with reference to the accompanying drawings. However, some components that are not related to the gist of the disclosure will be omitted or compressed, but the omitted components do not necessarily mean that they are not necessary for the present disclosure and may be combined and used by a person skilled in the art to which the present disclosure pertains.

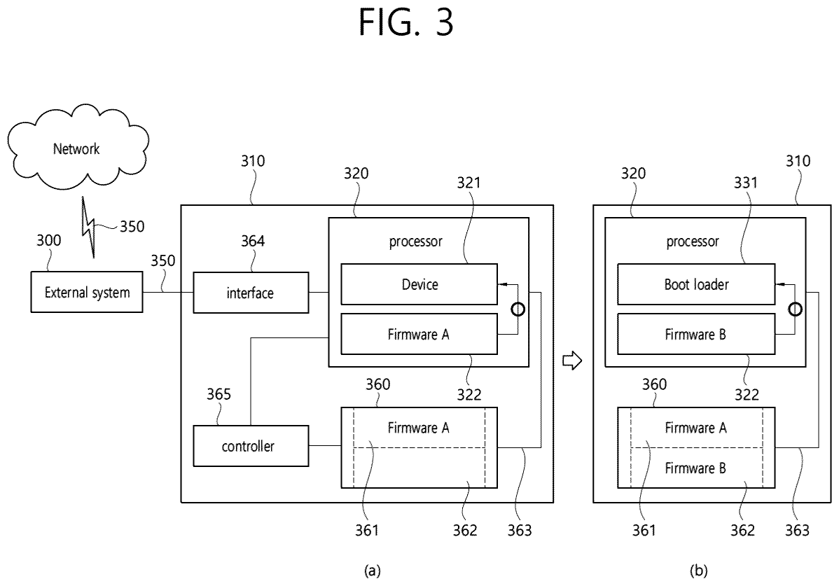

FIG. 3 is a drawing illustrating firmware updating using a processor assembly and a firmware change operation in a processor assembly during booting according to an embodiment of the present disclosure.

As shown in (a) of FIG. 3, a processor assembly 310 of the present disclosure may include a processor 320, an external memory 360, and an interface 364. The processor 320 and the external memory 360 are connected through a data line 363, and communication between the external system 300 and the processor assembly 310 is performed through the interface 364. Here, the processor includes an MCU.

The external system 300 receives new firmware B 350 through OTA, and then the external system 300 transmits firmware B to a nonvolatile memory (SRAM, not shown) inside the processor 320 through communication with the processor 320 in which firmware A stored in a flash memory 322 for XiP inside the processor 320 is being executed. Here, the interface 364 may use UART, SIP, etc. The new firmware B received through communication with the external system 300 is written to the external memory 360 through the data line 363.

Here, the processor 320 may be any commercial processor having one flash memory 322 for XiP therein. Also, the external memory 360 may be a memory without an XiP function and may have a dual bank structure including an A bank 361 and a B bank 362.

As shown in FIG. 3, the A bank 361 of the external memory 360 stores firmware A in advance, and the B bank 362 is a blank without firmware, but the A bank 361 and the B bank 362 may not have firmware written in advance, and firmware may be written in advance in the B bank 362, and firmware stored in the A bank 361 may be different from the firmware running in the processor 320.

As shown in FIG. 3, the processor assembly 310 may include a controller 365, and the controller 365 determines a write location of updated firmware by checking a flag indicating a version or presence of firmware written in advance in each bank 361 and 362 of the external memory 360. Here, the controller 365 may be disposed inside the processor 320 or inside the external memory 360.

Referring to FIG. 3, firmware updating process using OTA according to an embodiment of the present disclosure is performed in the external memory 360 rather than the internal flash memory 322 of the processor 320, so that even during the OTA update, the device 321 inside or outside the processor 320 performs firmware A stored in the flash memory 322 inside the processor 320, and thus, the operation using firmware A of the processor 320 is not interrupted.
(b) of FIG. 3 illustrates a state of the processor 320 and the external memory 360 after the OTA update, and it can be seen that new firmware B is written in the B bank 362 of the external memory 360. When booting after the update, the boot loader 331 of the processor 320 copies the firmware B of the B bank 362 to the flash memory 322 of the processor 320 through the data line 363 and executes new firmware B.

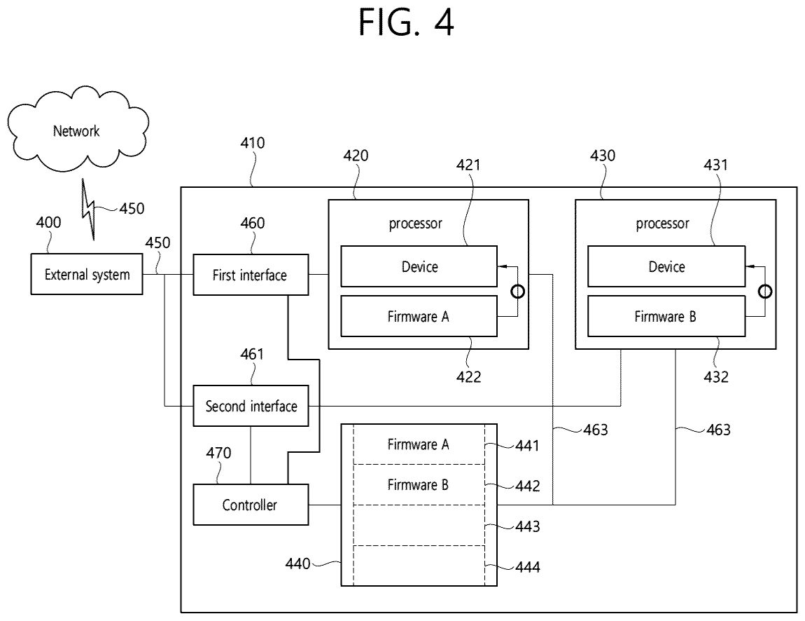

FIG. 4 is a drawing illustrating firmware updating using a processor assembly and a firmware change operation in the processor assembly during booting according to another embodiment of the present disclosure.

As illustrated in FIG. 4, the processor assembly 410 according to another embodiment of the present disclosure may include a first processor 420, a second processor 430, an external memory 440, and a first interface 460, and the first processor 420 and the second processor 430 are connected to the external memory 440 through a data line 463.

As illustrated in FIG. 4, the external memory 440 has a structure including an A bank 441, a B bank 442, a C bank 443, and a D bank 444. The A bank 441 has firmware A stored in advance, the B bank 442 has firmware B stored in advance, and the C bank 443 and the D bank 444 are blanks without firmware. However, the firmware version and presence stored in each bank may be changed variously.

The external system 400 receives new firmware C and D 450 sequentially or simultaneously through OTA, and thereafter, the external system 400 transfers the new firmware C and D to the internal memory (SRAM, not shown) of the first processor 420 and the second processor 430 through first and second interfaces 460 and 461. Thereafter, the new firmware C and D received via OTA communication are written to the C bank 443 and the D bank 444 of the external memory 440 via the data line 463. Here, the functions of the first and second interfaces 460 and 461 may be implemented in one interface.

Here, the first processor 420 and the second processor 430 may be any commercial processors respectively having one flash memory 422 and one flash memory 432 for XiP therein and may also be configured with three or more processors as long as the memory capacity is supported. In addition, it is illustrated that the external memory 440 is a memory without a XiP function and may include a plurality of banks therein.

Referring to FIG. 4, the processor assembly 410 further includes a controller 470, and the controller 470 determines a write location of firmware to be updated by checking a flag indicating a version or presence of firmware written in advance for each bank partitioned in the external memory 440.

In this manner, in the processor assembly 410 having a plurality of processors 420 and 430 and the external memory 440, the external memory 440 is divided into a plurality of banks and firmware is stored, so that firmware to be updated may be written to a target processor according to a schedule or a set order.

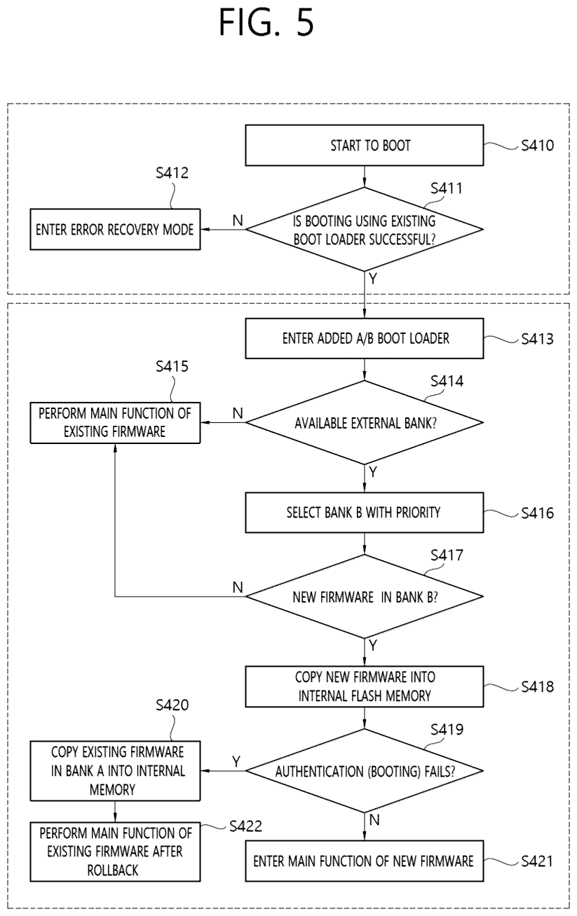

FIG. 5 is a booting flowchart of a processor after firmware updating according to an embodiment of the present disclosure.

The booting flowchart of FIG. 5 is performed in the processor assembly 310 of FIG. 3, which is an embodiment of the present disclosure, and is performed in the state of the processor 320 and the external memory 360 shown in (b) of FIG. 3. First, when booting starts (operation S410), the processor 320 attempts to boot using the existing boot loader (operation S411), and if booting fails, the processor 320 enters a recovery mode (operation S412).

If booting is successful in operation S411, the processor 320 enters the boot loader 331 added in the updating process (operation S413). The added boot loader 331 searches the external memory 360 for an available bank (operation S414). If there is an available bank, the processor 320 selects a bank with high priority (operation S416). Here, the priority may include a bank with a recent history of data being written.

If there is no available bank in operation S414, a main function of the existing firmware is performed (operation S415).

After operation S416, it is checked whether there is a new firmware in the high priority bank (operation S417), and if there is a new firmware in the high priority bank, the new firmware in the high priority bank is copied to the flash memory 322 inside the processor 320 (operation S418).

If there is no new firmware in the high priority bank in operation S417, operation S415 is performed.

If there is an authentication failure of the new firmware copied to the flash memory 322 inside the processor 320 or a booting failure using the new firmware after operation S418, the existing firmware in the existing bank is copied to the internal flash memory 322 (operation S420), and the main function of the existing firmware is performed after rollback (operation S422).

If the authentication of the new firmware copied to the flash memory 322 inside the processor 320 and the booting using the new firmware are successful in operation S419, the main function of the new firmware is entered (operation S421).

What is claimed is:

1. An electronic device capable of seamless firmware updating, the electronic device comprising:
a processor having a first firmware stored in a single flash memory supporting a software execution (execute in place (XiP)) function using an external memory;
the external memory located outside the processor and not having an XiP function storing a second firmware; and
an interface receiving a third firmware from an external system having the third firmware through communication with the external system via OTA (Over The Air).

2. The electronic device of claim 1, wherein
the processor and the external memory are connected by a data line, and the third firmware of the external system is transmitted to the external memory and written through the data line.

3. The electronic device of claim 1, wherein the interface is connected to the processor, and the third firmware received through the interface is transmitted to the external memory via the processor and written to the external memory.

4. The electronic device of claim 1, wherein the external memory is partitioned into a plurality of banks, and each of the partitioned banks stores different firmware.

5. The electronic device of claim 1, further comprising:
a controller determining a write location in one of partitioned banks for firmware to be updated stored in a non-volatile memory of the processor by checking a flag indicating a version or presence of different firmware written in each of the partitioned banks of the external memory.

6. A booting method of a processor in an electronic device capable of seamless firmware updating, including a processor supporting a software execution (execute in place (XiP)) function using an external memory, the external memory located outside the processor and not having an XiP function, and an interface receiving a firmware from an external system having the firmware through communication with the external system via OTA (Over The Air), the booting method after updating the firmware comprising:
an operation in which the processor attempts to boot using an existing boot loader;
an operation in which, when the booting is successful, the processor enters a boot loader added in an updating process, and the added boot loader searches the external memory for an available bank;
an operation in which, when there is a new firmware in an available bank, the boot loader copies the new firmware to a flash memory inside the processor; and
an operation in which authentication of the new firmware copied to the flash memory inside the processor is successful and booting using the new firmware is successful, a main function of the new firmware is entered.

7. The booting method of claim 6, wherein the operation in which the added boot loader searches the external memory for an available bank includes searching for a bank with a history of the latest firmware updating.

8. The booting method of claim 6, further comprising:
an operation in which, when the authentication of the new firmware copied to the flash memory fails or the booting using the new firmware fails, the existing firmware in the existing bank is copied to the internal flash memory of the processor, and a main function of the existing firmware is performed after rollback.

9. An electronic device capable of seamless firmware updating, the electronic device comprising:
a plurality of processors having firmware being executed in flash memory supporting an eXecute in place (XiP) function using external memory;
one external memory located outside the plurality of processors and not having an XiP function for storing a plurality of firmwares; and
at least one interface receiving firmware to be updated from an external system having the firmware to be updated through OTA (Over The Air) communication with the external system.

10. The electronic device of claim 9, wherein the plurality of processors and the one external memory are connected by a data line, and the firmware to be updated is transmitted and written from the plurality of processors to the one external memory through the data line.

11. The electronic device of claim 9, wherein the at least one interface is connected to the plurality of processors, and the firmware to be updated received through the at least one interface is transmitted to the one external memory via the plurality of processors and written to the one external memory.

12. The electronic device of claim 9, wherein the one external memory is partitioned into a plurality of banks, and each of the partitioned banks stores different firmware.

13. The electronic device of claim 9, further comprising:
a controller determining a write location in one of partitioned banks for firmware to be updated stored in a non-volatile memory of the plurality of processors by checking a flag indicating a version or presence of different firmware written in each of the partitioned banks of the one external memory.
